(19) United States
(12) Patent Application Publication
(10) Pub. No.: US 2021/0382637 A1
(43) Pub. Date: Dec. 9, 2021

(54) STORAGE DEVICE AND METHOD OF OPERATING THE STORAGE DEVICE

(71) Applicant: SK hynix Inc., Icheon-si Gyeonggi-do (KR)

(72) Inventors: Sang Ha LEE, Icheon-si Gyeonggi-do (KR); Dae Sung KIM, Icheon-si Gyeonggi-do (KR)

(73) Assignee: SK hynix Inc., Icheon-si Gyeonggi-do (KR)

(21) Appl. No.: 17/068,109

(22) Filed: Oct. 12, 2020

(30) Foreign Application Priority Data
Jun. 5, 2020 (KR) 10-2020-0068102

(51) Int. Cl. G06F 3/06

(52) U.S. Cl. CPC G06F 3/0623; G06F 3/064; G06F 3/0679; G06F 3/0656; G06F 3/0659

(57) ABSTRACT

The present technology relates to an electronic device. According to the present technology, a storage device having a life may include a memory device including a plurality of planes respectively including memory blocks, a buffer memory configured to temporarily store data chunks to be stored in the memory device, and a memory controller configured to control the memory device and the buffer memory so that the data chunks are distributed and stored in the plurality of planes, respectively.

### CROSS-REFERENCE TO RELATED APPLICATION

The present application claims priority under 35 U.S.C. § 119(a) to Korean patent application number 10-2020-0068102 filed on Jun. 5, 2020, in the Korean Intellectual Property Office, the entire disclosure of which is incorporated by reference herein.

### BACKGROUND

### 1. Technical Field

The present disclosure relates to an electronic device, and more particularly, to a storage device and a method of operating the storage device.

### 2. Related Art

A storage device is a device that stores data under control of a host device such as a computer or a smartphone. The storage device may include a memory device storing data and a memory controller controlling the memory device. The memory device may be classified into a volatile memory device and a non-volatile memory device.

The volatile memory device may be a device that stores data only when power is supplied and loses the stored data when the power supply is cut off. The volatile memory device may include a static random access memory (SRAM), a dynamic random access memory (DRAM), and the like.

The non-volatile memory device is a device that does not lose data even though power is cut off. The non-volatile memory device includes a read only memory (ROM), a programmable ROM (PROM), an electrically programmable ROM (EPROM), an electrically erasable and programmable ROM (EEPROM), a flash memory, and the like.

### SUMMARY

A memory controller that controls a memory device including a plurality of planes according to an embodiment of the present disclosure may include a buffer memory configured to temporarily store data chunks to be stored in the memory device, a data converter configured to convert the data chunks into scrambled data chunks, wherein each data chunk includes sub data chunks and each scrambled data chunk includes at least two or more sub data chunks selected from different data chunks, and an operation controller configured to provide program commands instructing to store the scrambled data chunks in the plurality of planes, respectively, to the memory device.

A memory controller that controls a memory device including a plurality of planes according to an embodiment of the present disclosure may include a buffer memory configured to temporarily store data chunks to be stored in the memory device, a data converter configured to divide the data chunks into at least two or more sub data chunks and scramble the sub data chunks from respective data chunks into different data chunks whereby the scrambled data chunks each include at least one sub data chunk from a first data chunk and at least one sub data chunk from a second data chunk different from the first data chunk, and an operation controller configured to provide program commands instructing to store the scrambled data chunks in the plurality of planes, respectively, to the memory device.

A method of operating a memory controller that controls a memory device including a plurality of planes according to an embodiment of the present disclosure may include receiving a logical address and a data chunk from a host, allocating a physical address indicating a page in which the data to be stored to the logical address, in the memory device, scrambling data chunks allocated to which physical addresses corresponding to pages included in different planes among the plurality of planes are allocated, and storing scrambled data chunks obtained according to the scrambling in the plurality of planes, respectively.

A storage device according to an embodiment of the present disclosure may include a memory device including a plurality of planes, a buffer memory configured to allocate physical addresses indicating positions in which data chunks received from a host are stored to logical addresses received together with the data chunks, and temporarily store the physical addresses and the data chunks, a data converter configured to convert data chunks to which physical addresses respectively corresponding to pages included in different planes among the plurality of planes are allocated into scrambled data chunks, and an operation controller configured to provide program commands instructing to store the scrambled data chunks in the plurality of planes, to the memory device.

A storage device according to an embodiment of the present disclosure may include a memory device including a plurality of planes respectively including memory blocks, a buffer memory configured to temporarily store data chunks to be stored in the memory device, and a memory controller configured to control the memory device and the buffer memory so that the data chunks are distributed and stored in the plurality of planes, respectively.

### BRIEF DESCRIPTION OF THE DRAWINGS

FIG. 1 is a diagram for describing a storage device according to an embodiment of the present disclosure.

FIG. 2 is a diagram for describing the storage of data without data scrambling.

FIG. 3 is a block diagram for describing a structure of a memory controller 200 of FIG. 1.

FIG. 4 is a diagram for describing distributing and storing data through data scrambling according to an embodiment.

FIG. 5 is a diagram for describing an embodiment of data scrambling.

FIG. 6 is a diagram for describing another embodiment of data scrambling.

FIG. 7 is a diagram for describing scrambling information according to data of FIG. 6.

FIG. 8 is a flowchart for describing an operation of the storage device according to an embodiment of the present disclosure.

FIG. 9 is a flowchart for describing a scrambling operation of FIG. 8.

FIG. 10 is diagram for describing a structure of a memory device 100 of FIG. 1.

FIG. 11 is a diagram illustrating an embodiment of a memory cell array of FIG. 10.

FIG. 12 is a circuit diagram illustrating any one memory block BLKa of memory blocks BLK1 to BLKz of FIG. 11.

FIG. 13 is a diagram for describing a structure of any one memory block BLKb among the memory blocks BLK1 to BLKz of FIG. 11.

FIG. 14 is a diagram for describing a structure of any one memory block BLKi among the memory blocks BLK1 to BLKz of FIG. 11.

FIG. 15 is a diagram illustrating an embodiment of a memory controller of FIG. 1.

FIG. 16 is a block diagram illustrating a memory card system to which the storage device according to an embodiment of the present disclosure is applied.

FIG. 17 is a block diagram illustrating a solid state drive (SSD) system to which the storage device according to an embodiment of the present disclosure is applied.

FIG. 18 is a block diagram illustrating a user system to which the storage device according to an embodiment of the present disclosure is applied.

### DETAILED DESCRIPTION

Specific structural or functional descriptions of embodiments according to the concepts which are disclosed in the present specification or application are illustrated only to describe the embodiments according to the concepts of the present disclosure. The embodiments according to the concepts of the present disclosure may be carried out in various forms and the descriptions are not limited to the embodiments described in the present specification or application.

An embodiment of the present disclosure provides a storage device having an improved life, and a method of operating the same.

According to the present technology, a storage device may have an improved life, and a method of operating the same are provided.

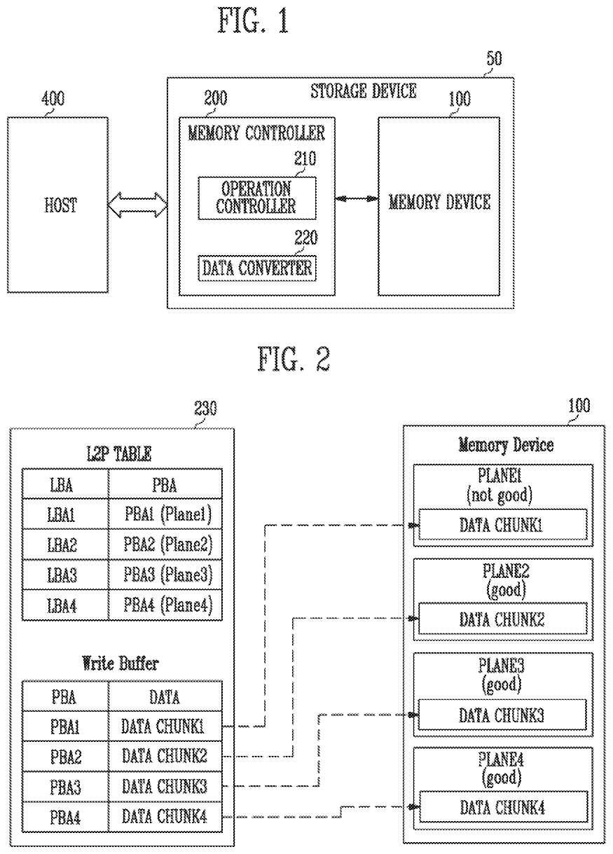

FIG. 1 is a diagram for describing a storage device according to an embodiment of the present disclosure.

Referring to FIG. 1, the storage device 50 may include a memory device 100 and a memory controller 200 that controls an operation of the memory device. The storage device 50 may be a device that stores data under control of a host 400 such as a cellular phone, a smartphone, an MP3 player, a laptop computer, a desktop computer, a game player, a TV, a tablet PC, or an in-vehicle infotainment system.

The storage device 50 may be manufactured as one of various types of storage devices according to a host interface that is a communication method with the host 400. For example, the storage device 50 may be configured as any one of various types of storage devices such as an SSD, a multimedia card in a form of an MMC, an eMMC, an RS-MMC and a micro-MMC, a secure digital card in a form of an SD, a mini-SD and a micro-SD, a universal serial bus (USB) storage device, a universal flash storage (UFS) device, a personal computer memory card international association (PCMCIA) card type storage device, a peripheral component interconnection (PCI) card type storage device, a PCI express (PCI-E) card type storage device, a compact flash (CF) card, a smart media card, and a memory stick.

The storage device 50 may be manufactured as any one of various types of packages. For example, the storage device 50 may be manufactured as any one of various types of package types, such as a package on package (POP), a system in package (SIP), a system on chip (SOC), a multi-chip package (MCP), a chip on board (COB), a wafer-level fabricated package (WFP), and a wafer-level stack package (WSP).

The memory device 100 may store data. The memory device 100 operates under control of the memory controller 200. The memory device 100 may include a memory cell array (not shown) including a plurality of memory cells that store data.

Each of the memory cells may be configured as a single level cell (SLC) that stores one data bit, a multi-level cell (MLC) that stores two data bits, a triple level cell (TLC) that stores three data bits, or a quad level cell (QLC) capable of storing four data bits.

The memory cell array (not shown) may include a plurality of memory blocks. One memory block may include a plurality of pages. In an embodiment, the page may be a unit for storing data in the memory device 100 or reading data stored in the memory device 100. The memory block may be a unit for erasing data.

In an embodiment, the memory device 100 may be a double data rate synchronous dynamic random access memory (DDR SDRAM), a low power double data rate4 (LPDDR4) SDRAM, a graphics double data rate (GDDR) SDRAM, a low power DDR (LPDDR), a Rambus dynamic random access memory (RDRAM), a NAND flash memory, a vertical NAND flash memory, a NOR flash memory device, a resistive random access memory (RRAM), a phase-change memory (PRAM), a magnetoresistive random access memory (MRAM), a ferroelectric random access memory (FRAM), a spin transfer torque random access memory (STT-RAM), or the like. In the present specification, for convenience of description, it is assumed that the memory device 100 is a NAND flash memory.

The memory device 100 is configured to receive a command CMD and an address ADDR from the memory controller 200 and access an area selected by an address in the memory cell array. The memory device 100 may perform an operation instructed by the command CMD on the area selected by the address ADDR. For example, the memory device 100 may perform a program operation, a read operation, and an erase operation. During the program operation, the memory device 100 may store data in the area selected by the address ADDR. During the read operation, the memory device 100 may read data from the area selected by the address ADDR. During the erase operation, the memory device 100 may erase data stored in the area selected by the address ADDR.

In an embodiment, the memory device 100 may include a plurality of planes. The plane may be a unit capable of independently performing an operation. For example, the memory device 100 may include two, four, or eight planes. The plurality of planes may independently perform a program operation, a read operation, or an erase operation simultaneously, respectively. The words “simultaneous” and “simultaneously” as used herein with respect to occurrences mean that the occurrences take place on overlapping intervals of time. For example, if a first occurrence takes place over a first interval of time and a second occurrence takes place simultaneously over a second interval of time, then the first and second intervals at least partially overlap each other such that there exists a time at which the first and second occurrences are both taking place.

The plane may include a plurality of memory blocks. When the memory device 100 includes the plurality of planes, reliability of memory cells included in each plane may be different. For example, the reliability of the memory cells may be different according to a physical position in which the memory cell is positioned in the memory device 100. Since all reliability of the memory cells are different, reliability of the memory blocks may also be different. In general, since the memory blocks belonging to the same plane are disposed in similar physical positions, the memory blocks belonging to the same plane may be treated as having similar reliability.

The memory controller 200 may control an overall operation of the storage device 50.

When power is applied to the storage device 50, the memory controller 200 may execute firmware (FW). When the memory device 100 is a flash memory device, the firmware (FW) may include a host interface layer (HIL) that controls communication with the host 400, a flash translation layer (FTL) that controls communication between the memory controller 200 and the host 400, and a flash interface layer (FIL) that controls communication with the memory device 100.

The memory controller 200 may include an operation controller 210 and a data converter 220.

The operation controller 210 may receive data and a logical block address LBA from the host 400 and may convert the logical block address LBA into a physical block address PBA indicating an address of memory cells in which data included in the memory device 100 is to be stored. In the present specification, the logical block address LBA and a “logic address” or a “logical address” may be used as the same meaning. In the present specification, the physical block address PBA and a “physical address” may be used as the same meaning.

The operation controller 210 may control the memory device 100 to perform the program operation, the read operation, or the erase operation according to a request of the host 400. During the program operation, the operation controller 210 may provide a write command, the physical block address PBA, and data to the memory device 100. During the read operation, the operation controller 210 may provide a read command and the physical block address PBA to the memory device 100. During the erase operation, the operation controller 210 may provide an erase command and the physical block address PBA to the memory device 100.

In an embodiment, the operation controller 210 may generate a command, an address, and data independently, regardless of the request from the host 400, and transmit the command, the address, and the data to the memory device 100. For example, the operation controller 210 may provide a command, an address, and data for performing a read operation and program operations accompanying in performing wear leveling, read reclaim, garbage collection, and the like, to the memory device 100.

In an embodiment, the memory controller 200 may control at least two or more memory devices 100. In this case, the memory controller 200 may control the memory devices 100 according to an interleaving method to improve operation performance. The interleaving method may be a method of controlling operations for at least two memory devices 100 to overlap with each other. Alternatively, the interleaving method may be a method in which at least two or more memory devices 100 operate in parallel.

A buffer memory (not shown) may temporarily store data provided from the host 400, that is, data to be stored in the memory device 100, or may temporarily store data read from the memory device 100. In an embodiment, the buffer memory (not shown) may be a volatile memory device. For example, the buffer memory (not shown) may be a dynamic random access memory (DRAM) or a static random access memory (SRAM).

The data converter 220 may convert data to be stored in the memory device 100.

For convenience of description, a data unit stored in one physical page included in the memory device 100 is defined as a data chunk.

The data converter 220 may scramble data chunks to be stored in different planes when the operation controller 210 allocates a physical block address in which the data chunk is to be stored. For example, the data converter 220 may divide (parse) the data chunks to be stored in different planes into a plurality of sub data chunks. The data converter 220 may generate scrambled data chunks including sub data chunks divided from different data chunks among the divided plurality of sub data chunks.

In an embodiment, the operation controller 210 may provide the memory device 100 with a program command instructing to store the scrambled data chunks in an area corresponding to the physical block address where the data chunks are to be stored.

In an embodiment, the number of data chunks and the number of scrambled data chunks may be the same.

In an embodiment, the number of data chunks may be the same as the number of planes included in the memory device 100.

In an embodiment, the number of sub data chunks divided from the data chunk may be the same as the number of planes included in the memory device 100.

In an embodiment, the number of sub data chunks included in the scramble data chunk may be the same as the number of planes included in the memory device 100.

The data converter 220 may generate scrambling information, which is information on the data chunks scrambled together, and may store the scrambling information. In an embodiment, the scrambling information may include a physical block address of the data chunks, a physical block address of the scrambled data chunks, a physical block address where the sub data chunks are to be stored, and position information indicating a number of chunks in a page in which the sub data chunks are stored. Here, the physical block address may include any one of a plane address, a block address, or a page address.

During the read operation, when the logical block address LBA is provided from the host 400, the operation controller 210 may obtain the physical block address PBA mapped to the logical block address LBA. For example, the operation controller 210 may obtain a physical block address PBA corresponding to the logical block address LBA requested to be read from a logical physical table L2P TABLE stored in the buffer memory (not shown).

The operation controller 210 may obtain scrambled data chunks to be read based on the scrambling information stored by the data converter 220 during the program operation and physical block addresses in which the scrambled data chunks are stored. Read commands for requesting the scrambled data chunks stored in the memory device may be provided to the memory device.

When the scrambled data chunks read by the memory device 100 are provided, the operation controller 210 may control the data converter 220 to descramble the scrambled data chunks using the scrambling information. Therefore, the memory controller 200 may obtain original data corresponding to the logical block address LBA requested by the host 400.

According to an embodiment of the present disclosure, when data chunks are converted into the scrambled data chunks through scrambling and stored, data to be stored in memory cells having relatively low reliability may be divided and stored in memory cells having relatively high reliability. Therefore, data may be prevented from being stored only in the memory cells having relatively low reliability.

The host 400 may communicate with the storage device 50 using at least one of various communication methods such as a universal serial bus (USB), a serial AT attachment (SATA), a serial attached SCSI (SAS), a high speed interchip (HSIC), a small computer system interface (SCSI), a peripheral component interconnection (PCI), a PCI express (PCIe), a nonvolatile memory express (NVMe), a universal flash storage (UFS), a secure digital (SD), a multi-media card (MMC), an embedded MMC (eMMC), a dual in-line memory module (DIMM), a registered DIMM (RDIMM), and a load reduced DIMM (LRDIMM).

FIG. 2 is a diagram for describing the storage of data without data scrambling.

Referring to FIG. 2, a buffer memory 230 may include an L2P table and a write buffer. The L2P table may be a table indicating a mapping relationship between the logical block address LBA provided by the host 400 described with reference to FIG. 1 and the physical block address PBA of the memory cells of the memory device 100. In FIG. 2, it is assumed that first to fourth logical block addresses LBA1 to 4 are mapped to first to fourth physical block addresses PBA1 to 4, respectively. The first physical block address PBA1 may be a physical block address indicating memory cells included in a first plane PLANE1 among first to fourth planes PLANE1 to PLANE4 included in the memory device 100. For example, the first physical block address PBA1 may be a physical block address indicating any one page included in a memory block included in the first plane PLANE1. In the same manner, the second physical block address PBA2 may be a physical block address indicating any one page included in a memory block included in the second plane PLANE2, the third physical block address PBA3 may be a physical block address indicating any one page included in a memory block included in the third plane PLANE3. The fourth physical block address PBA4 may be a physical block address indicating any one page included in a memory block included in the fourth plane PLANE4.

The write buffer may temporarily store data to be stored in the memory device 100. The write buffer may include a physical block address PBA in which data to be stored and a data chunk to be stored in corresponding memory cells. For example, the logical block addresses LBA and the physical block addresses PBA may be mapped so that first to fourth data chunks DATA CHUNK1 to CHUNK4 are stored in the first to fourth physical block addresses PBA1 to PBA4, respectively.

The buffer memory 230 may be included inside the memory controller 200 described with reference to FIG. 1, or may be implemented as independent hardware outside the memory controller 200. The buffer memory 230 may be a volatile memory.

The operation controller 210 described with reference to FIG. 1 may provide the memory device 100 with program commands instructing to store the first to fourth data chunks DATA CHUNK1 to CHUNK4 in the first to fourth physical block addresses PBA1 to PBA4, respectively, as stored in the write buffer.

The memory device 100 may include the first to fourth planes PLANE1 to PLANE4. In FIG. 2, it is assumed that reliability of memory cells included the first plane PLANE1 is relatively not good and reliability of memory cells included the remaining second to fourth planes PLANE2 to PLANE4 is relatively good in the memory device 100 through a test process.

Thereafter, when DATA CHUNK1 to CHUNK4 are read from the respective planes, more error bits may be included in the data chunk stored in the plane 1 PLANE1 including memory cells having less reliability. As a result, a memory block included in the plane 1 PLANE1 may be determined, earlier, as a bad block, and a life of the memory device 100 might not be improved.

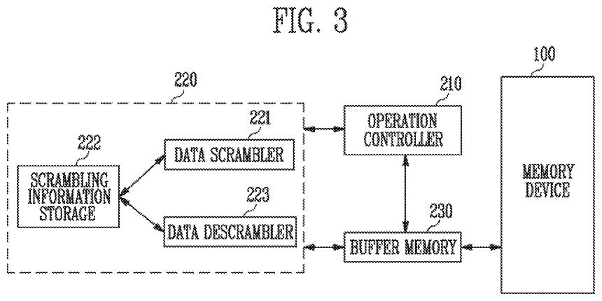

FIG. 3 is a block diagram for describing a structure of the memory controller 200 of FIG. 1.

Referring to FIG. 3, the memory controller 200 may include the operation controller 210, the data converter 220, and the buffer memory 230.

The operation controller 210 may receive the data chunk and the logical block address LBA, which is an address for identifying the corresponding data chunk, from the host 400 described with reference to FIG. 1, and may convert the logical block address LBA into the physical block address PBA indicating a page address where the data chunk is to be stored. For example, the operation controller 210 may allocate the physical block address PBA in which the data chunk is to be stored.

The L2P table, which is the table indicating the mapping relationship between the logical block address LBA provided by the host 400 and the physical block address PBA of the memory device 100, may be stored in the buffer memory 230.

In an embodiment, the buffer memory 230 may further include a write buffer. The operation controller 210 may temporarily store the data chunk to which the physical block address PBA is allocated to the write buffer.

The data converter 220 may include a data scrambler 221 that performs data scrambling, a data descrambler 223 that performs data descrambling, and a scrambling information storage 222 that stores the scrambling information. In an embodiment, the scrambling information storage 222 may be included in the buffer memory 230.

The data scrambler 221 may determine data chunks of which the allocated physical block addresses PBA are different from each other among the data chunks stored in the write buffer as data chunks to be scrambled.

In an embodiment, the number of data chunks to be scrambled may be the same as the number of planes included in the memory device 100. In an embodiment, the data chunks may be data allocated with the physical block address PBA corresponding to different planes.

The data scrambler ′221 may scramble data chunks to be stored in different planes. For example, the data scrambler 221 may divide (parse) each of the data chunks to be stored in different planes into a plurality of sub data chunks.

At this time, the data scrambler 221 may divide each data chunk into the sub data chunks corresponding to the number of planes included in the memory device 100.

The data scrambler 221 may generate scrambled data chunks configured of only the sub data chunks divided from different data chunks among the plurality of divided sub data chunks. That is, the scrambled data chunks include the sub data chunks corresponding to the number of planes included in the memory device 100, and the sub data chunks included in the scramble data chunk may be data divided from different data chunks.

In an embodiment, the number of data chunks and the number of scrambled data chunks may be the same.

The data scrambler 221 may generate the scrambling information, which is information on the scrambled data chunks, and store the scrambling information in the scrambling information storage 222. In an embodiment, the scrambling information may include the physical block address of the data chunks, the physical block address of the scrambled data chunks, the physical block addresses where the sub data chunks are to be stored, and the position information indicating a number of sub chunks in the page. Here, the physical block address may include any one of the plane address, the block address, or the page address.

In an embodiment, the operation controller 210 may provide the memory device 100 with the program command instructing to store the scrambled data chunks in the area corresponding to the physical block address where the data chunks are to be stored.

During the read operation, when the logical block address LBA is provided from the host 400, the operation controller 210 may obtain the physical block address PBA mapped to the logical block address LBA. For example, the operation controller 210 may obtain a physical block address PBA corresponding to the logical block address LBA requested to be read from the logical physical table L2P TABLE stored in the buffer memory 230.

The operation controller 210 may obtain the physical block addresses PBA where the scrambled data chunks scrambled together when the data chunk, which is stored in the physical block address PBA corresponding to the logical block address LBA requested to be read from the host 400 based on the scrambling information stored in the scrambling information storage 222, is stored.

The operation controller 210 may provide the read commands for requesting the scrambled data chunks stored in the memory device 100 to the memory device.

When the scrambled data chunks read by the memory device 100 are provided to the memory controller 200, the operation controller 210 may control the data converter 220 to descramble the scrambled data chunks using the scrambling information. Therefore, the memory controller 200 may obtain the data chunk corresponding to the logical block address LBA requested by the host 400.

According to an embodiment of the present disclosure, the data chunks may be converted into the scrambled data chunks through scrambling and stored. That is, the data chunk to be stored in one page may be divided into the plurality of sub data chunks, and each of the sub data chunks may be distributed and stored in pages belonging to different planes. Thus, data to be stored in memory cells having relatively low reliability may be divided and stored in memory cells having relatively high reliability. Therefore, data may be prevented from being stored only in the memory cells having relatively low reliability.

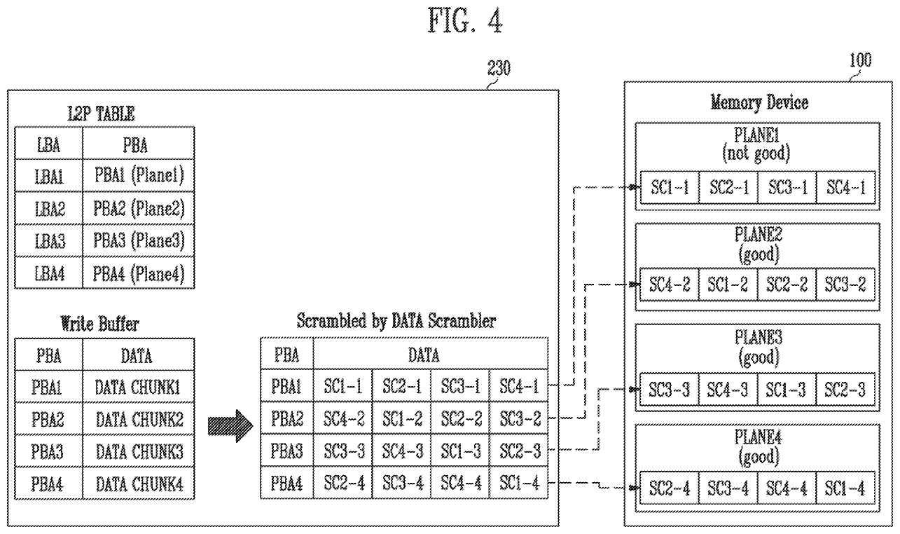

FIG. 4 is a diagram for describing distributing and storing data through the data scrambling according to an embodiment.

Referring to FIG. 4, the buffer memory 230 may include an L2P table and a write buffer. The L2P table and the write buffer are the same as the L2P table and the write buffer described in the embodiment of FIG. 2.

For example, in a state in which the logical block addresses LBA and the physical block addresses PBA are mapped so that the first to fourth data chunks DATA CHUNK1 to CHUNK4 are stored in the first to fourth physical block addresses PBA1 to PBA4, respectively, the memory controller 200 may perform a data scrambling operation.

The first data chunk DATA CHUNK1 may include (1-1)-th to (1-4)-th sub data chunks SC1-1 to SC1-4. The second data chunk DATA CHUNK2 may include (2-1)-th to (2-4)-th sub data chunks SC2-1 to SC2-4. The third data chunk DATA CHUNK3 may include (3-1)-th to (3-4)-th sub data chunks SC3-1 to SC3-4. The fourth data chunk DATA CHUNK1 may include (4-1)-th to (4-4)-th sub data chunks SC4-1 to SC4-4.

The number of scrambled data chunks of which scrambling is completed may be the same as the number of data chunks as four.

The scrambled data chunk to be stored in the first physical block address PBA1 may include a (1-1)-th sub data chunk SC1-1, a (2-1)-th sub data chunk SC2-1, a (3-1)-th sub data chunk SC3-1, and a (4-1)-th sub data chunk SC4-1.

The scrambled data chunk to be stored in the second physical block address PBA2 may include a (4-2)-th sub data chunk SC4-2, a (1-2)-th sub data chunk SC1-2, a (2-2)-th sub data chunk SC2-2, and a (3-2)-th sub data chunk SC3-2.

The scrambled data chunk to be stored in the third physical block address PBA3 may include a (3-3)-th sub data chunk SC3-3, a (4-3)-th sub data chunk SC4-3, a (1-3)-th sub data chunk SC1-3, and a (2-3)-th sub data chunk SC2-3.

The scrambled data chunk to be stored in the fourth physical block address PBA4 may include a (2-4)-th sub data chunk SC2-4, a (3-4)-th sub data chunk SC3-4, a (4-4)-th sub data chunk SC4-4, and a (1-4)-th sub data chunk SC1-4.

In comparison with the embodiment described with reference to FIG. 2, the first to fourth data chunks DATA CHUNK1 to CHUNK4 are divided and stored in the first plane PLANE1 having relatively low reliability in FIG. 4.

Assuming that the host 400 requests data corresponding to the first logical block address LBA1, in the embodiment of FIG. 2, the read operation is performed on the first plane PLANE1 having the relatively low reliability. Conversely, in the embodiments of FIG. 4, in order to obtain the first data chunk DATA CHUNK1, all of the (1-1)-th to (1-4)-th sub data chunks are required to be read, and thus the read operation is required to be performed on all of the first to fourth planes PLANE1 to PLANE4. In this case, the number of error bits included in the scramble data chunk stored in the relatively low first plane PLANE1 may be greater than that of error bits included in the scramble data chunk stored in the remaining planes. However, differently from the embodiment of FIG. 2 in which the error bit is included only in the first data chunk DATA CHUNK1 requested by the host 400, in the embodiments of FIG. 4, the generated error bits are distributed and stored in the (1-1)-th sub data chunk SC1-1, the (2-1)-th sub data chunk SC2-1, the (3-1)-th sub data chunk SC3-1, and the (4-1)-th sub data chunk SC4-1. Therefore, the total number of error bits included in the (1-1)-th to (1-4)-th sub data chunks may be less than the number of error bits included in the first data chunk DATA CHUNK1 of FIG. 2.

As a result, the number of error bits caused by the memory cells having low reliability may be distributed by distributing and storing data in the first to fourth planes PLANE1 to PLANE4. As a result, a specific memory block having low reliability may be prevented from being first processed as a bad block. As a result, the memory device 100 may be used longer.

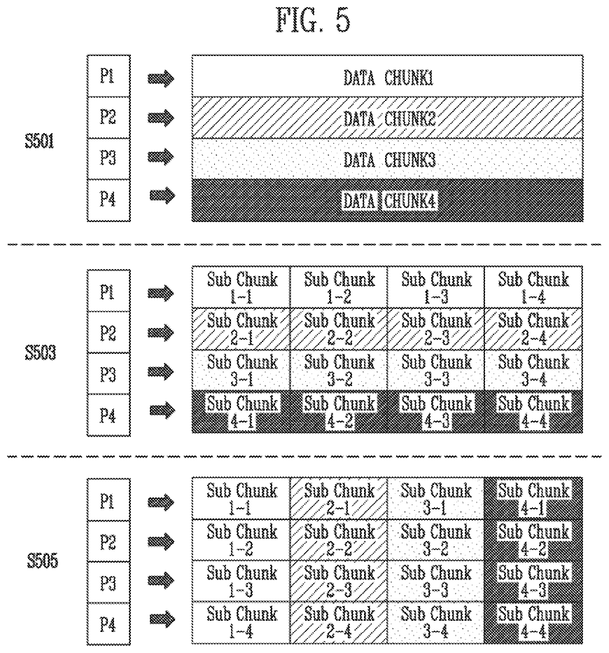

FIG. 5 is a diagram for describing an embodiment of data scrambling.

Referring to FIGS. 3 and 5, the data scrambler 221 may determine the data chunks to which the physical block addresses PBA indicating different planes are allocated as scrambling target data chunks. That is, the data scrambler 221 may scramble the data chunks scheduled to be stored in different planes. Scrambling may be an operation of converting data so that each data chunk may be distributed and stored in a plurality of planes.

S501 indicates a state in which a physical block address PBA corresponding to a first plane P1 is allocated to the first data chunk DATA CHUNK1, a physical block address PBA corresponding to a second plane P2 is allocated to the second data chunk DATA CHUNK2, a physical block address PBA corresponding to a third plane P3 is allocated to the third data chunk DATA CHUNK3, and a physical block address PBA corresponding to a fourth plane P4 is allocated to the fourth data chunk DATA CHUNK4.

The data scrambler 221 may divide each of the plurality of data chunks into the plurality of sub data chunks (S503). The number of sub data chunks included in one data chunk may be the same as the number of planes. S503 indicates a state in which a first data chunk is divided to include (1-1)-th to (1-4)-th sub data chunks Sub Chunk 1-1 to Sub Chunk 1-4, a second data chunk is divided to include (2-1)-th to (2-4)-th sub data chunks Sub Chunk 2-1 to Sub Chunk 2-4, a third data chunk is divided to include (3-1)-th to (3-4)-th sub data chunks Sub Chunk 3-1 to Sub Chunk 3-4, and a fourth data chunk is divided to include (4-1)-th to (4-4)-th sub data chunks Sub Chunk 4-1 to Sub Chunk 4-4.

The data scrambler 221 generates a plurality of scrambled data chunks using the plurality of sub data chunks (S505). Here, the plurality of scrambled data chunks may be configured of only sub data chunks divided from different data chunks, respectively.

S505 indicates that sub data chunks having the same sequence among the sub data chunks included in each of the data chunks are converted into one scrambled data chunk. That is, the first scrambled data chunk may include the (1-1)-th to (4-1)-th sub data chunks Sub Chunk 1-1 to 4-1, the second scrambled data chunk may include the (1-2)-th to (4-2)-th sub data chunks Sub Chunk 1-2 to 4-2, the third scrambled data chunk may include the (1-3)-th to (4-3)-th sub data chunks Sub Chunk 1-3 to 4-3, and the fourth scrambled data chunk may include the (1-4)-th to (4-4)-th sub data chunks Sub Chunk 1-4 to 4-4.

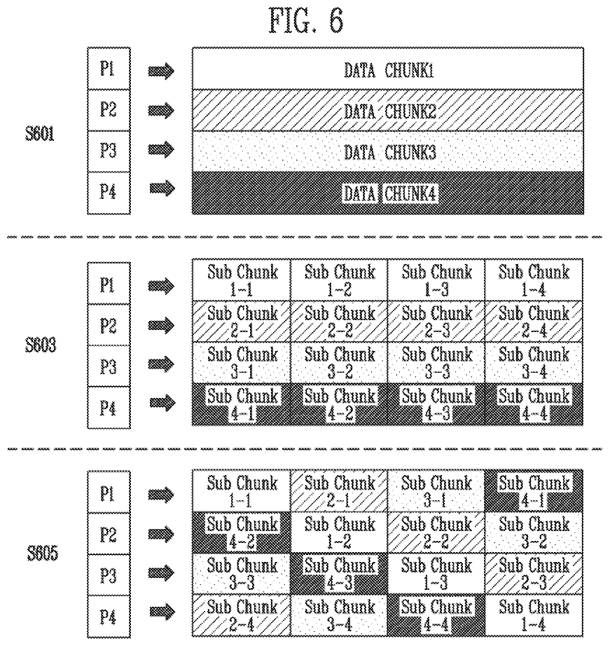

FIG. 6 is a diagram for describing another embodiment of data scrambling.

In the embodiments of FIGS. 6, S601 and S603 are the same as S501 and S503 described with reference to FIG. 5, respectively, and description thereof will be omitted.

A difference between the embodiment of FIG. 6 and the embodiment of FIG. 5 is a sequence of the sub data chunks included in the scramble data chunk in S605. S605 is the same as S505 in that the sub data chunks included in the same position configure one scrambled data chunk. However, S605 indicates a case where the sequence in the scrambled data chunk is not included in the same position differently from the embodiments of FIG. 5.

In addition to the embodiments of FIGS. 5 and 6, when the scrambled data chunk is configured of only the sub data chunks divided from different data chunks, the sequence may be any form.

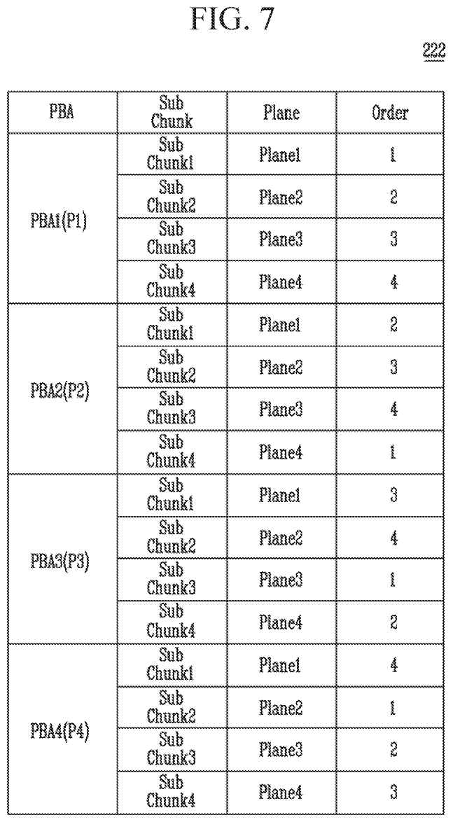

FIG. 7 is a diagram for describing the scrambling information according to the data of FIG. 6.

Referring to FIG. 7, the scrambling information storage 222 may include a physical block address Source PBA before conversion of scrambling target data chunks, physical block addresses Destination PBA where the sub data chunks are to be stored, and position information Order indicating a number of sub chunks in the page. Here, the physical block address may include any one of the plane addresses, the block addresses, or the page addresses.

The scrambling information of FIG. 7 indicates scrambling information generated based on the scrambled data chunks described with reference to FIG. 6. The scrambling information is sufficient to include changed physical block addresses PBA of the data chunk before scrambling and the sub data chunks after scrambling, and is not limited to the embodiments of FIG. 7.

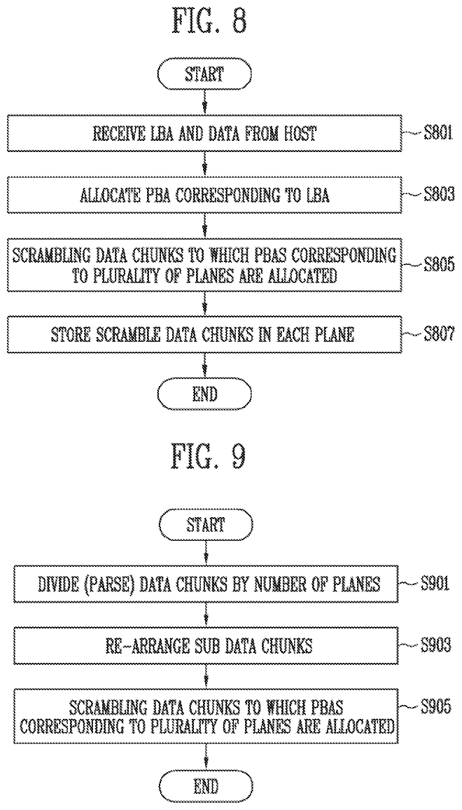

FIG. 8 is a flowchart for describing an operation of the storage device according to an embodiment of the present disclosure.

Referring to FIG. 8, in step S801, the storage device may receive the LBA and the data chunk from the host.

In step S803, the storage device may allocate the PBA corresponding to the LBA.

In step S805, the storage device may scramble the data chunks allocated to the PBAs corresponding to different planes.

In step S807, the storage device may store the scrambled data chunks generated (converted) according to scrambling in each of the planes.

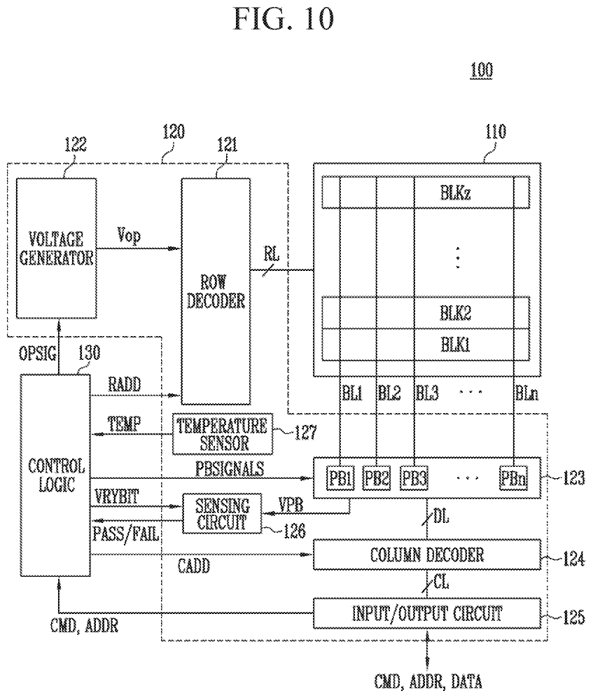

FIG. 9 is a flowchart for describing a scrambling operation of FIG. 8.

Referring to FIG. 9, in step S901, the storage device may divide (parse) the data chunks to be stored in different planes into the plurality of sub data chunks, respectively.

At this time, the data scramble 221 may divide each data chunk into the sub data chunks corresponding to the number of planes included in the memory device 100.

In step S903, the storage device may generate the scrambled data chunks configured of only the sub data chunks divided from different data chunks among the plurality of sub data chunks. That is, each of the scrambled data chunks may include the sub data chunks corresponding to the number of planes included in the memory device 100, and the sub data chunks included in the scramble data chunk may be data divided from different data chunks.

In step S905, the storage device may generate the scrambling information, which is information on the scrambled data chunks, and store the scrambling information. In an embodiment, the scrambling information may include the physical block address of the data chunks, the physical block address of the scrambled data chunks, the physical block addresses where the sub data chunks are to be stored, and the position information indicating a number of sub chunks in the page. Here, the physical block address may include any one of the plane address, the block address, or the page address.

FIG. 10 is diagram for describing a structure of the memory device 100 of FIG.

Referring to FIG. 10, the memory device 100 may include a memory cell array 110, a peripheral circuit 120, and control logic 130. The control logic 130 may be implemented as hardware, software, or a combination of hardware and software. For example, the control logic 130 may be a control logic circuit operating in accordance with an algorithm and/or a processor executing control logic code.

The memory cell array 110 includes a plurality of memory blocks BLK1 to BLKz. The plurality of memory blocks BLK1 to BLKz are connected to a row decoder 121 through row lines RL. The plurality of memory blocks BLK1 to BLKz may be connected to the page buffer group 123 through bit lines BL1 to BLn. Each of the plurality of memory blocks BLK1 to BLKz includes a plurality of memory cells. As an embodiment, the plurality of memory cells may be non-volatile memory cells. Memory cells connected to the same word line may be defined as one page. Therefore, one memory block may include a plurality of pages.

The row lines RL may include at least one source select line, a plurality of word lines, and at least one drain select line.

Each of the memory cells included in the memory cell array 110 may be configured as a single level cell (SLC) that stores one data bit, a multi-level cell (MLC) that stores two data bits, a triple level cell (TLC) that stores three data bits, or a quad level cell (QLC) that stores four data bits.

The peripheral circuit 120 may be configured to perform the program operation, the read operation, or the erase operation on a selected region of the memory cell array 110 under control of the control logic 130. The peripheral circuit 120 may drive the memory cell array 110. For example, the peripheral circuit 120 may apply various operation voltages to the row lines RL and the bit lines BL1 to BLn or discharge the applied voltages under the control of the control logic 130.

The peripheral circuit 120 may include a row decoder 121, a voltage generator 122, the page buffer group 123, a column decoder 124, and an input/output circuit 125.

The row decoder 121 is connected to the memory cell array 110 through the row lines RL. The row lines RL may include at least one source select line, a plurality of word lines, and at least one drain select line. In an embodiment, the word lines may include normal word lines and dummy word lines. In an embodiment, the row lines RL may further include a pipe select line.

The row decoder 121 is configured to operate in response to control of the control logic 130. The row decoder 121 receives a row address RADD from the control logic 130.

The row decoder 121 is configured to decode the row address RADD received from the control logic 130. The row decoder 121 selects at least one memory block among the memory blocks BLK1 to BLKz according to a decoded address. In addition, the row decoder 121 may select at least one word line of the memory block selected to apply the voltages generated by the voltage generator 122 to at least one word line WL according to the decoded address.

For example, during the program operation, the row decoder 121 may apply a program voltage to a selected word line and apply a program pass voltage of a level lower than the program voltage to an unselected word line. During a program verify operation, the row decoder 121 may apply a verify voltage to the selected word line and a verify pass voltage higher than the verify voltage to the unselected word line. During the read operation, the row decoder 121 may apply a read voltage to the selected word line and apply a read pass voltage higher than the read voltage to the unselected word line.

In an embodiment, the erase operation of the memory device 100 is performed in a memory block unit. During the erase operation, the row decoder 121 may select one memory block according to the decoded address. During the erase operation, the row decoder 121 may apply a ground voltage to the word lines connected to the selected memory block.

The voltage generator 122 operates in response to the control of the control logic 130. The voltage generator 122 is configured to generate a plurality of voltages using an external power voltage supplied to the memory device 100. For example, the voltage generator 122 may generate various operation voltages Vop used for the program, read, and erase operations, in response to operation signal OPSIG. For example, the voltage generator 122 may generate the program voltage, the verify voltage, the pass voltage, the read voltage, the erase voltage, and the like in response to the control of the control logic 130.

As an embodiment, the voltage generator 122 may generate an internal power voltage by regulating the external power voltage. The internal power voltage generated by the voltage generator 122 is used as an operation voltage of the memory device 100.

As an embodiment, the voltage generator 122 may generate a plurality of voltages using the external power voltage or the internal power voltage.

For example, the voltage generator 122 may include a plurality of pumping capacitors that receive the internal power voltage, and may selectively activate the plurality of pumping capacitors to generate the plurality of voltages, in response to the control of the control logic 130.

The generated plurality of voltages may be supplied to the memory cell array 110 by the row decoder 121.

The page buffer group 123 includes first to n-th page buffers PB1 to PBn. The first to n-th page buffers PB1 to PBn are connected to the memory cell array 110 through the first to n-th bit lines BL1 to BLn, respectively. The first to n-th page buffers PB1 to PBn operate in response to the control of the control logic 130. For example, the first to n-th page buffers PB1 to PBn may operate in response to page buffer control signals PBSIGNALS. For example, the first to n-th page buffers PB1 to PBn may temporarily store data received through the first to n-th bit lines BL1 to BLn, or may sense a voltage or a current of the bit lines BL1 to BLn during the read or verify operation.

For example, during the program operation, when the program pulse is applied to the selected word line, the first to n-th page buffers PB1 to PBn may transfer data DATA received from the input/output circuit 125 to the selected memory cell through the first to n-th bit lines BL1 to BLn. The memory cells of the selected page are programmed according to the transferred data DATA. A threshold voltage of the memory cell connected to the bit line to which a program permission voltage (for example, a ground voltage) is applied may rise. The threshold voltage of the memory cell connected to the bit line to which a program inhibit voltage (for example, a power voltage) is applied may be maintained. During the program verify operation, the first to n-th page buffers PB1 to PBn may read data stored in the memory cells from the selected memory cells through the first to n-th bit lines BL1 to BLn.

During the read operation, the first to n-th page buffers PB1 to PBn read the data DATA from the memory cells of the selected page through the first to n-th bit lines BL1 to BLn, and outputs the read data DATA to the input/output circuit 125 under the control of the column decoder 124.

During the erase operation, the first to n-th page buffers PB1 to PBn may float the first to n-th bit lines BL1 to BLn.

The column decoder 124 may transfer data between the input/output circuit 125 and the page buffer group 123 in response to a column address CADD. For example, the column decoder 124 may exchange data with the first to n-th page buffers PB1 to PBn through data lines DL, or may exchange data with the input/output circuit 125 through column lines CL.

The input/output circuit 125 may transfer the command CMD and the address ADDR received from the memory controller 200 described with reference to FIG. 1 to the control logic 130, or may exchange data DATA with the column decoder 124.

The sensing circuit 126 may generate a reference current in response to a permission bit signal VRYBIT during the read operation or the program verify operation, and compare a sensing voltage VPB received from the page buffer group 123 with a reference voltage generated by the reference current to output a pass signal PASS or a fail signal FAIL.

A temperature sensor 127 may measure a temperature of the memory device 100. The temperature sensor 127 may provide a temperature signal TEMP having a different voltage level according to the measured temperature to the control logic 130. The control logic 130 may generate temperature information TEMP INFO indicating the temperature of the memory device 100 according to the temperature signal TEMP, and output the generated temperature information TEMP INFO to the outside.

The control logic 130 may output the operation signal OPSIG, the row address RADD, the page buffer control signals PBSIGNALS, and the permission bit VRYBIT in response to the command CMD and the address ADDR to control the peripheral circuit 120. In addition, the control logic 130 may determine whether the verity operation is passed or failed in response to the pass or fail signal PASS or FAIL.

In an embodiment, the data converter 220 described with reference to FIGS. 1 and 3 may be implemented inside the memory device 100 rather than the memory controller 200. In this case, the memory controller may provide the memory device 100 with the program command instructing to store data in the physical block address PBA converted by the L2P table. The memory device 100 may perform the data scrambling operation described with reference to FIGS. 1 and 3 using the received data, and may generate scrambled data chunks by itself. In this case, the memory device 100 may store the scrambling information in a meta area or a system area rather than an area in which user data is stored among areas included in the memory cell array 110.

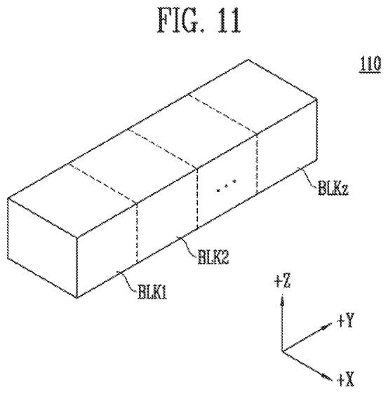

FIG. 11 is a diagram illustrating an embodiment of the memory cell array of FIG. 10.

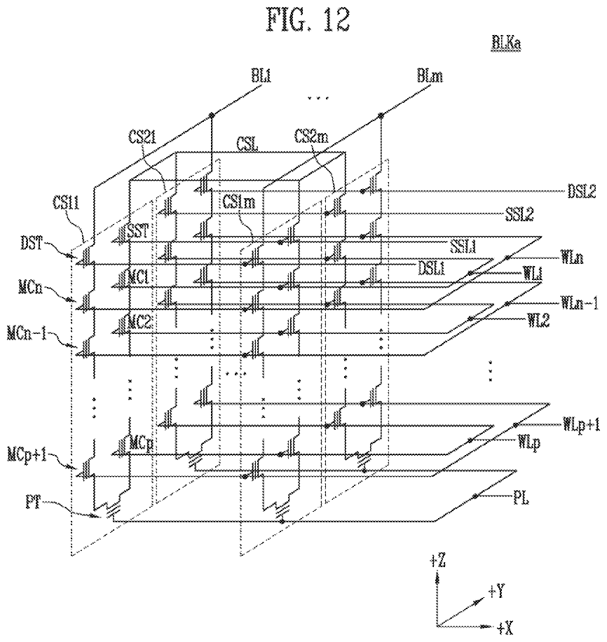

Referring to FIG. 11, the memory cell array 110 includes a plurality of memory blocks BLK1 to BLKz. Each memory block may have a three-dimensional structure. Each memory block includes a plurality of memory cells stacked on a substrate. Such plurality of memory cells are arranged along a +X direction, a +Y direction, and a +Z direction. A structure of each memory block is described in more detail with reference to FIGS. 12 to 14.

FIG. 12 is a circuit diagram illustrating any one memory block BLKa of the memory blocks BLK1 to BLKz of FIG. 11.

Referring to FIG. 12, the memory block BLKa includes a plurality of cell strings CS11 to CS1m and CS21 to CS2m. As an embodiment, each of the plurality of cell strings CS11 to CS1m and CS21 to CS2m may be formed in a ‘U’ shape. In the memory block BLKa, m cell strings are arranged in a row direction (that is, the +X direction). In FIG. 12, two cell strings are arranged in a column direction (that is, the +Y direction). However, this is for convenience of description and it may be understood that three or more cell strings may be arranged in the column direction.

Each of the plurality of cell strings CS11 to CS1m and CS21 to CS2m includes at least one or more source select transistors SST, first to n-th memory cells MC1 to MCn, a pipe transistor PT, and at least one drain select transistor DST.

Each of the select transistors SST and DST and the memory cells MC1 to MCn may have a similar structure. As an embodiment, each of the select transistors SST and DST and the memory cells MC1 to MCn may include a channel layer, a tunneling insulating film, a charge storage film, and a blocking insulating film. As an embodiment, a pillar for providing the channel layer may be provided in each cell string. As an embodiment, a pillar for providing at least one of the channel layer, the tunneling insulating film, the charge storage film, and the blocking insulating film may be provided in each cell string.

The source select transistor SST of each cell string is connected between a common source line CSL and the memory cells MC1 to MCp.

As an embodiment, the source select transistors of the cell strings arranged in the same row are connected to a source select line extending in the row direction, and the source select transistors of the cell strings arranged in different rows are connected to different source select lines. In FIG. 12, the source select transistors of the cell strings CS11 to CS1m of a first row are connected to a first source select line SSL1. The source select transistors of the cell strings CS21 to CS2m of a second row are connected to a second source select line SSL2.

As another embodiment, the source select transistors of the cell strings CS11 to CS1m and CS21 to CS2m may be commonly connected to one source select line.

The first to n-th memory cells MC1 to MCn of each cell string are connected between the source select transistor SST and the drain select transistor DST.

The first to n-th memory cells MC1 to MCn may be divided into first to p-th memory cells MC1 to MCp and (p+1)-th to n-th memory cells MCp+1 to MCn. The first to p-th memory cells MC1 to MCp are sequentially arranged in a direction opposite to the +Z direction, and are connected in series between the source select transistor SST and the pipe transistor PT. The (p+1)-th to n-th memory cells MCp+1 to MCn are sequentially arranged in the +Z direction, and are connected in series between the pipe transistor PT and the drain select transistor DST. The first to p-th memory cells MC1 to MCp and the (p+1)-th to n-th memory cells MCp+1 to MCn are connected to each other through the pipe transistor PT. Gates of the first to n-th memory cells MC1 to MCn of each cell string are connected to the first to n-th word lines WL1 to WLn, respectively.

A gate of the pipe transistor PT of each cell string is connected to a pipeline PL.

The drain select transistor DST of each cell string is connected between a corresponding bit line and the memory cells MCp+1 to MCn, The cell strings arranged in the row direction are connected to the drain select line extending in the row direction. The drain select transistors of the cell strings CS11 to CS1m of the first row are connected to a first drain select line DSL1. The drain select transistors of the cell strings CS21 to CS2m of the second row are connected to a second drain select line DSL2.

The cell strings arranged in the column direction are connected to the bit lines extending in the column direction. In FIG. 12, the cell strings CS11 and CS21 of the first column are connected to the first bit line BL1. The cell strings CS1m and CS2m of the m-th column are connected to the m-th bit line BLm. In an embodiment, the first to m-th bit lines BL1 to BLm may correspond to the first to n-th bit lines BL1 to BLn described with reference to FIG. 10.

The memory cells connected to the same word line in the cell strings arranged in the row direction configure one page. For example, the memory cells connected to the first word line WL1, among the cell strings CS11 to CS1m of the first row configure one page. The memory cells connected to the first word line WL1, among the cell strings CS21 to CS2m of the second row configure another page. The cell strings arranged in one row direction may be selected by selecting any one of the drain select lines DSL1 and DSL2. One page of the selected cell strings may be selected by selecting any one of the word lines WL1 to WLn.

As another embodiment, even bit lines and odd bit lines may be provided instead of the first to m-th bit lines BL1 to BLm. In addition, even-numbered cell strings among the cell strings CS11 to CS1m or CS21 to SC2m arranged in the row direction may be connected to the bit lines, and odd-numbered cell strings among the cell strings CS11 to CS1m or CS21 to CS2m arranged in the row direction may be connected to odd bit lines, respectively.

As an embodiment, at least one of the first to n-th memory cells MC1 to MCn may be used as a dummy memory cell. For example, at least one dummy memory cell is provided to reduce an electric field between the source select transistor SST and the memory cells MC1 to MCp. Alternatively, at least one dummy memory cell is provided to reduce an electric field between the drain select transistor DST and the memory cells MCp+1 to MCn. As more dummy memory cells are provided, reliability of an operation for the memory block BLKa is improved, however, the size of the memory block BLKa increases. As less memory cells are provided, the size of the memory block BLKa may be reduced, however, the reliability of the operation for the memory block BLKa may be reduced.

In order to efficiently control at least one dummy memory cell, each of the dummy memory cells may have a required threshold voltage. Before or after an erase operation for the memory block BLKa, program operations for all or a part of the dummy memory cells may be performed. When the erase operation is performed after the program operation is performed, the dummy memory cells may have the required threshold voltage by controlling a voltage applied to dummy word lines connected to the respective dummy memory cells.

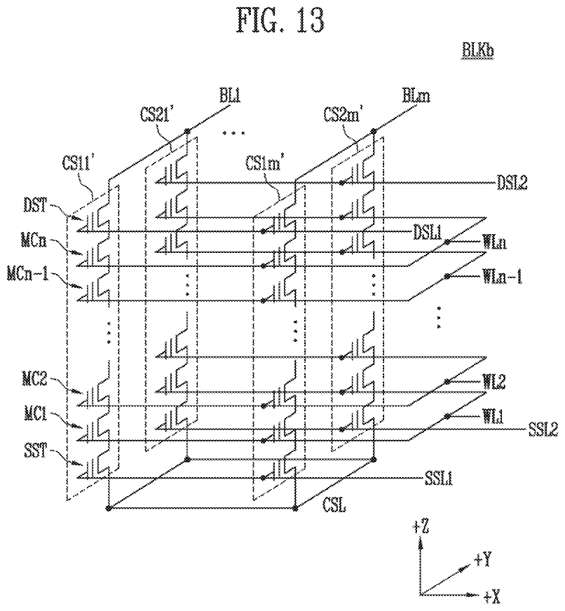

FIG. 13 is a diagram for describing a structure of any one memory block BLKb among the memory blocks BLK1 to BLKz of FIG. 11.

Referring to FIG. 13, the memory block BLKb includes a plurality of cell strings CS11′ to CS1m′ and CS21′ to CS2m′. Each of the plurality of cell strings CS11′ to CS1m′ and CS21′ to CS2m′ extends along a +Z direction. Each of the plurality of cell strings CS11′ to CS1m′ and CS21′ to CS2m′ includes at least one source select transistor SST, first to n-th memory cells MC1 to MCn, and at least one drain select transistor DST stacked on a substrate (not shown) under the memory block BLK1′.

The source select transistor SST of each cell string is connected between a common source line CSL and memory cells MC1 to MCn. The source select transistors of the cell strings arranged in the same row are connected to the same source select line. The source select transistors of the cell strings CS11′ to CS1m′ arranged in a first row are connected to a first source select line SSL1. The source select transistors of the cell strings CS21′ to CS2m′ arranged in a second row are connected to a second source select line SSL2. As another embodiment, the source select transistors of the cell strings CS11′ to CS1m′ and CS21′ to CS2m′ may be commonly connected to one source select line.

The first to n-th memory cells MC1 to MCn of each cell string are connected in series between the source select transistor SST and the drain select transistor DST. Gates of the first to n-th memory cells MC1 to MCn are connected to first to the n-th word lines WL1 to WLn, respectively.

The drain select transistor DST of each cell string is connected between a corresponding bit line and the memory cells MC1 to MCn. The drain select transistors of the cell strings arranged in the row direction are connected to a drain select line extending in the row direction. The drain select transistors of the cell strings CS11′ to CS1m′ of a first row are connected to a first drain select line DSL1. The drain select transistors of the cell strings CS21′ to CS2m′ of a second row are connected to a second drain select line DSL2.

As a result, the memory block BLKb of FIG. 13 has an equivalent circuit similar to the memory block BLKa of FIG. 12 except that the pipe transistor PT is excluded from each cell string.

As another embodiment, even bit lines and odd bit lines may be provided instead of the first to m-th bit lines BL1 to BLm. In addition, even-numbered cell strings among the cell strings CS11′ to CS1m′ or CS21′ to CS2m′ arranged in the row direction may be connected to even bit lines, and odd-numbered cell strings among the cell strings CS11′ to CS1m′ or CS21′ to CS2m′ arranged in the row direction may be connected to odd bit lines, respectively.

As an embodiment, at least one of the first to n-th memory cells MC1 to MCn may be used as a dummy memory cell. For example, at least one dummy memory cell is provided to reduce an electric field between the source select transistor SST and the memory cells MC1 to MCn. Alternatively, at least one dummy memory cell is provided to reduce an electric field between the drain select transistor DST and the memory cells MC1 to MCn. As more dummy memory cells are provided, reliability of an operation for the memory block BLKb is improved, however, the size of the memory block BLKb increases. As less memory cells are provided, the size of the memory block BLKb may be reduced, however, the reliability of the operation for the memory block BLKb may be reduced.

In order to efficiently control at least one dummy memory cell, each of the dummy memory cells may have a required threshold voltage. Before or after an erase operation for the memory block BLKb, program operations for all or a part of the dummy memory cells may be performed. When the erase operation is performed after the program operation is performed, the dummy memory cells may have the required threshold voltage by controlling a voltage applied to the dummy word lines connected to the respective dummy memory cells.

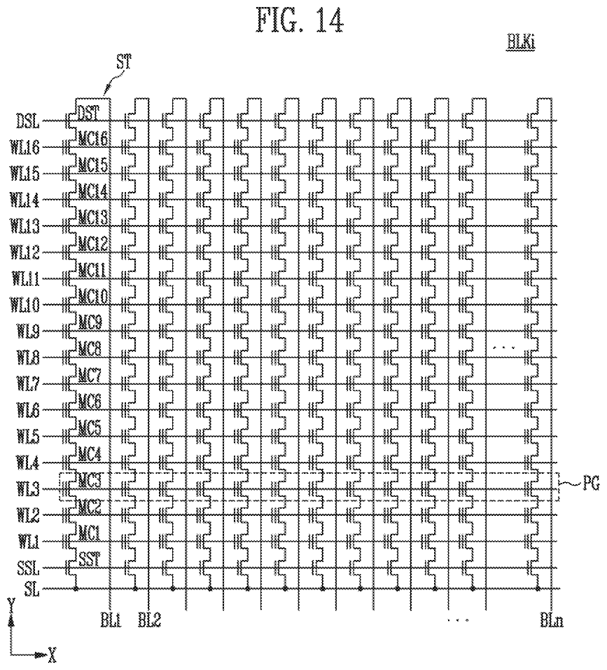

FIG. 14 is a diagram for describing a structure of any one memory block BLKi among the memory blocks BLK1 to BLKz of FIG. 11.

Referring to FIG. 14, a plurality of word lines arranged in parallel with each other may be connected between the first select line and the second select line. Here, the first select line may be the source select line SSL, and the second select line may be the drain select line DSL. For example, the memory block 110 may include a plurality of strings ST connected between the bit lines BL1 to BLn and the source line SL. The bit lines BL1 to BLn may be connected to the strings ST, respectively, and the source line SL may be commonly connected to the strings ST. Since the strings ST may be configured to be identical to each other, a string ST connected to the first bit line BL1 will be specifically described, as an example.

The string ST may include a source select transistor SST, a plurality of memory cells MC1 to MC16, and a drain select transistor DST connected in series between the source line SL and the first bit line BL1. One string ST may include at least one or more of the source select transistor SST and the drain select transistor DST, and may include the memory cells MC1 to MC16 more than the number shown in the figure.

A source of the source select transistor SST may be connected to the source line SL and a drain of the drain select transistor DST may be connected to the first bit line BL1. The memory cells MC1 to MC16 may be connected in series between the source select transistor SST and the drain select transistor DST. Gates of the source select transistors SST included in the different strings ST may be connected to the source select line SSL, gates of the drain select transistors DST may be connected to the drain select line DSL, and gates of the memory cells MC1 to MC16 may be connected to the plurality of word lines WL1 to WL16. A group of the memory cells connected to the same word line among the memory cells included in different strings ST may be referred to as a page PG. Therefore, the memory block BLKi may include the pages PG of the number of the word lines WL1 to WL16.

One memory cell may store one bit of data. This is commonly called a single level cell (SLC). In this case, one physical page PG may store one logical page (LPG) data. The one logical page (LPG) data may include data bits of the same number as cells included in one physical page PG.

The one memory cell may store two or more bits of data. In this case, one physical page PG may store two or more logical page (LPG) data.

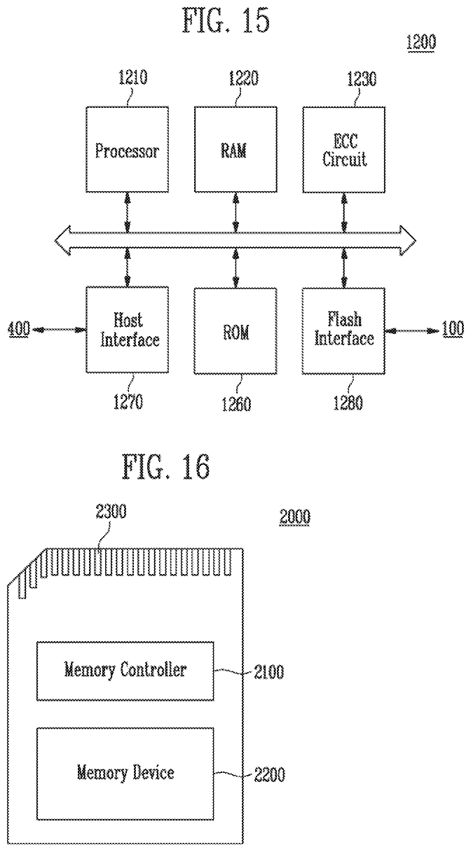

FIG. 15 is a diagram illustrating an embodiment of the memory controller of FIG. 1.

Referring to FIGS. 1 and 15, the memory controller 1200 may include a processor 1210, a RAM 1220, an error correction circuit 1230, a ROM 1260, a host interface 1270, and a flash interface 1280.

The processor 1210 may control overall operations of the memory controller 1200. The RAM 1220 may be used as a buffer memory, a cache memory, and an operation memory of the memory controller 1200.

The ROM 1260 may store various information required for the memory controller 1200 to operate in a firmware form.

The memory controller 1200 may communicate with an external device (for example, the host 400, an application processor, and the like) through the host interface 1270.

The error correction circuit 1230 may encode data to be stored in the memory device 100 using an error correction code. The encoded data may be stored in the memory device 100 through scrambling described with reference to FIGS. 1 and 3. During the read operation, the read data may be recovered to data before scrambling according to descrambling, and the error correction circuit 1230 may decode the corresponding data. When decoding is passed, original data initially provided by the host may be recovered. When decoding is failed, the memory controller 1200 may perform various defense algorithms to recover the original data.

According to an embodiment of the disclosure, the scrambling operation is performed in order to collect the plurality of data chunks before storing the data and divide and store the data chunks in the plurality of planes so that all data stored in the memory device 100 have a similar error occurrence rate, based on an idea that the reliability of the memory cells may be different according to the position of the page included in the memory device 100, the position of the block, or the position of the plane.

Meanwhile, even the memory cells included in the same plane, the reliability may differ according to a physical position of the memory cells in the same page. Therefore, even in the same page, the error occurrence rate may vary according to the position of the sub data chunk stored in the same page.

In an embodiment, the error correction circuit 1230 may apply initial log likelihood ratio (LLR) values used for decoding as different values according to the reliability of the memory cell.

In another embodiment, the error correction circuit 1230 may correct an error with a stronger error correction capability in the data stored in the memory cell having less reliability using a unequal error protection (UEP) technique from code design for encoding, and the error correction circuit 1230 may be disposed at a node having a higher error correction capability during encoding.

The memory controller 1200 may communicate with the memory device 100 through the flash interface 1280. The memory controller 1200 may transmit a command CMD, an address ADDR, and a control signal CTRL to the memory device 100 and receive data DATA through the flash interface 1280. For example, the flash interface 1280 may include a NAND interface.

FIG. 16 is a block diagram illustrating a memory card system to which the storage device according to an embodiment of the present disclosure is applied.

Referring to FIG, 16, the memory card system 2000 includes a memory controller 2100, a memory device 2200, and a connector 2300.

The memory controller 2100 is connected to the memory device 2200. The memory controller 2100 is configured to access the memory device 2200. For example, the memory controller 2100 may be configured to control read, write, erase, and background operations of the memory device 2200. The memory controller 2100 is configured to provide an interface between the memory device 2200 and a host. The memory controller 2100 is configured to drive firmware for controlling the memory device 2200. The memory controller 2100 may be implemented equally to the memory controller 200 described with reference to FIG. 1.

For example, the memory controller 2100 may include components such as a random access memory (RAM), a processor, a host interface, a memory interface, and an error corrector.

The memory controller 2100 may communicate with an external device through the connector 2300. The memory controller 2100 may communicate with an external device (for example, the host) according to a specific communication standard. For example, the memory controller 2100 is configured to communicate with an external device through at least one of various communication standards such as a universal serial bus (USB), a multimedia card (MMC), an embedded MMC (MCM), a peripheral component interconnection (PCI), a PCI express (PCI-E), an advanced technology attachment (ATA), a serial-ATA, a parallel-ATA, a small computer system interface (SCSI), an enhanced small disk interface (ESDI), integrated drive electronics (IDE), FireWire, a universal flash storage (UFS), Wi-Fi, Bluetooth, and an NVMe. For example, the connector 2300 may be defined by at least one of the various communication standards described above.

For example, the memory device 2200 may be configured of various non-volatile memory elements such as an electrically erasable and programmable ROM (EEPROM), a NAND flash memory, a NOR flash memory, a phase-change RAM (PRAM), a resistive RAM (ReRAM), a ferroelectric RAM (FRAM), and a spin-torque magnetic RAM (STT-MRAM).

The memory controller 2100 and the memory device 2200 may be integrated into one semiconductor device to configure a memory card. For example, the memory controller 2100 and the memory device 2200 may be integrated into one semiconductor device to configure a memory card such as a PC card (personal computer memory card international association (PCMCIA)), a compact flash card (CF), a smart media card (SM or SMC), a memory stick, a multimedia card (MMC, RS-MMC, MMCmicro, or eMMC), an SD card (SD, miniSD, microSD, or SDHC), and a universal flash storage (UFS).

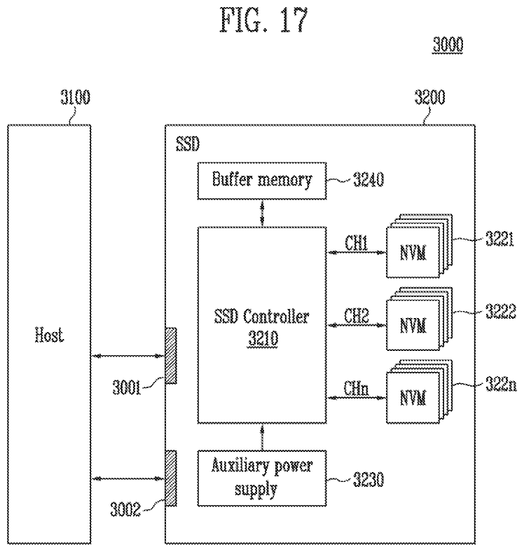

FIG. 17 is a block diagram illustrating a solid state drive (SSD) system to which the storage device according to an embodiment of the present disclosure is applied.

Referring to FIG. 17, the SSD system 3000 includes a host 3100 and an SSD 3200. The SSD 3200 exchanges a signal SIG with the host 3100 through a signal connector 3001 and receives power PWR through a power connector 3002. The SSD 3200 includes an SSD controller 3210, a plurality of flash memories 3221 to 322n, an auxiliary power device 3230, and a buffer memory 3240.

According to an embodiment of the present disclosure, the SSD controller 3210 may perform the function of the memory controller 200 described with reference to FIG. 1.

The SSD controller 3210 may control the plurality of flash memories 3221 to 322n in response to the signal SIG received from the host 3100. For example, the signal SIG may be signals based on an interface between the host 3100 and the SSD 3200. For example, the signal SIG may be a signal defined by at least one of interfaces such as a universal serial bus (USB), a multimedia card (MMC), an embedded MMC (MCM), a peripheral component interconnection (PCI), a PCI express (PCI-E), an advanced technology attachment (ATA), a serial-ATA, a parallel-ATA, a small computer system interface (SCSI), an enhanced small disk interface (ESDI), integrated drive electronics (IDE), FireWire, a universal flash storage (UFS), Wi-Fi, Bluetooth, and an NVMe.

The auxiliary power device 3230 is connected to the host 3100 through the power connector 3002. The auxiliary power device 3230 may receive the power PWR from the host 3100 and may charge the power. The auxiliary power device 3230 may provide power of the SSD 3200 when power supply from the host 3100 is not smooth. For example, the auxiliary power device 3230 may be positioned in the SSD 3200 or may be positioned outside the SSD 3200. For example, the auxiliary power device 3230 may be positioned on a main board and may provide auxiliary power to the SSD 3200.

The buffer memory 3240 operates as a buffer memory of the SSD 3200. For example, the buffer memory 3240 may temporarily store data received from the host 3100 or data received from the plurality of flash memories 3221 to 322n, or may temporarily store meta data (for example, a mapping table) of the flash memories 3221 to 322n. The buffer memory 3240 may include a volatile memory such as a DRAM, an SDRAM, a DDR SDRAM, an LPDDR SDRAM, and a GRAM, or a non-volatile memory such as an FRAM, a ReRAM, an STT-MRAM, and a PRAM.

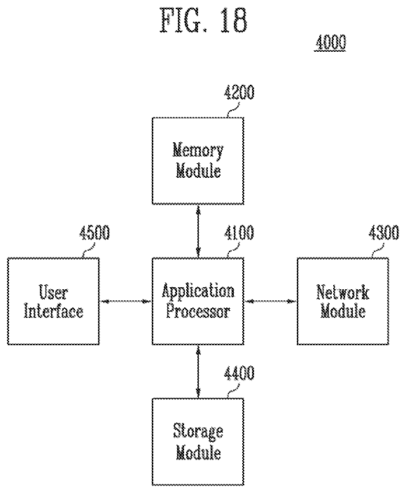

FIG. 18 is a block diagram illustrating a user system to which the storage device according to an embodiment of the present disclosure is applied.

Referring to FIG. 18, the user system 4000 includes an application processor 4100, a memory module 4200, a network module 4300, a storage module 4400, and a user interface 4500.

The application processor 4100 may drive components, an operating system (OS), a user program, or the like included in the user system 4000. For example, the application processor 4100 may include controllers, interfaces, graphics engines, and the like that control the components included in the user system 4000. The application processor 4100 may be provided as a system-on-chip (SoC).

The memory module 4200 may operate as a main memory, an operation memory, a buffer memory, or a cache memory of the user system 4000. The memory module 4200 may include a volatile random access memory such as a DRAM, an SDRAM, a DDR SDRAM, a DDR2 SDRAM, a DDR3 SDRAM, an LPDDR SDARM, an LPDDR2 SDRAM, and an LPDDR3 SDRAM, or a non-volatile random access memory, such as a PRAM, a ReRAM, an MRAM, and an FRAM. For example, the application processor 4100 and memory module 4200 may be packaged based on a package on package (POP) and provided as one semiconductor package.

The network module 4300 may communicate with external devices. For example, the network module 4300 may support wireless communication such as code division multiple access (CDMA), global system for mobile communications (GSM), wideband CDMA (WCDMA), CDMA-2000, time division multiple access (TDMA), long term evolution, Wimax, WLAN, UWB, Bluetooth, and Wi-Fi. For example, the network module 4300 may be included in the application processor 4100.

The storage module 4400 may store data. For example, the storage module 4400 may store data received from the application processor 4100. Alternatively, the storage module 4400 may transmit data stored in the storage module 4400 to the application processor 4100. For example, the storage module 4400 may be implemented as a non-volatile semiconductor memory element such as a phase-change RAM (PRAM), a magnetic RAM (MRAM), a resistive RAM (RRAM), a NAND flash, a NOR flash, and a three-dimensional NAND flash. For example, the storage module 4400 may be provided as a removable storage device (removable drive), such as a memory card, and an external drive of the user system 4000.

For example, the storage module 4400 may include a plurality of non-volatile memory devices, and the plurality of non-volatile memory devices may operate identically or similarly to the memory device 100 described with reference to FIG. 1. The storage module 4400 may operate identically or similarly to the storage device 50 described with reference to FIG. 1.

The user interface 4500 may include interfaces for inputting data or an instruction to the application processor 4100 or for outputting data to an external device. For example, the user interface 4500 may include user input interfaces such as a keyboard, a keypad, a button, a touch panel, a touch screen, a touch pad, a touch ball, a camera, a microphone, a gyroscope sensor, a vibration sensor, and a piezoelectric element. The user interface 4500 may include user output interfaces such as a liquid crystal display (LCD), an organic light emitting diode (OLED) display device, an active matrix OLED (AMOLED) display device, an LED, a speaker, and a monitor.

What is claimed is:

1. A memory controller that controls a memory device including a plurality of planes, the memory controller comprising:
a buffer memory configured to temporarily store data chunks to be stored in the memory device;
a data converter configured to convert the data chunks into scrambled data chunks, wherein each data chunk includes sub data chunks and each scrambled data chunk includes at least two or more sub data chunks selected from different data chunks; and
an operation controller configured to provide program commands instructing to store the scrambled data chunks in the plurality of planes, respectively, to the memory device.

2. The memory controller of claim 1, wherein the data converter comprises a data scrambler configured to obtain the sub data chunks obtained by dividing the data chunks by the number of the plurality of planes, and generate the scrambled data chunks including sub data chunks divided from different data chunks among the sub data chunks.

3. The memory controller of claim 2, wherein the scrambled data chunks include the sub data chunks corresponding to the number of the plurality of planes.

4. The memory controller of claim 2, wherein the buffer memory stores map data that is information on planes respectively corresponding to the data chunks among the plurality of planes.

5. The memory controller of claim 4, wherein the data scrambler generates scrambling information that is information on planes in which sub data chunks respectively included in the data chunks among the plurality of planes are to be stored.

6. The memory controller of claim 5, wherein the data converter further comprises a scrambling information storage configured to store the scrambling information.

7. The memory controller of claim 1, wherein the number of scrambled data chunks is the same as the number of the plurality of planes.

8. The memory controller of claim 1, wherein the operation controller obtains a physical block address corresponding to a logical block address provided from a host, obtains information on read scrambled data chunks including read sub data chunks included in a read data chunk corresponding to the physical block address, and provides read commands for requesting read scrambled data chunks stored in the memory device to the memory device.

9. The memory controller of claim 8, wherein the data converter further comprises a scrambling information storage configured to store scrambling information corresponding to the read data chunks, and
the scrambling information includes information on original data chunks of read sub data chunks respectively included in the read data chunks among the plurality of planes.

10. The memory controller of claim 9, further comprising:
a data descrambler configured to descramble the read data chunks using the scrambling information and obtain the original data chunks.

11. A method of operating a memory controller that controls a memory device including a plurality of planes, the method comprising:
receiving a logical address and a data chunk from a host;
allocating a physical address indicating a page in which the data to be stored to the logical address, in the memory device;
scrambling data chunks allocated to which physical addresses corresponding to pages included in different planes among the plurality of planes are allocated; and
storing scrambled data chunks obtained according to the scrambling in the plurality of planes, respectively.

12. The method of claim 11, wherein scrambling comprises:
dividing the data chunks into sub data chunks corresponding to the number of the plurality of planes; and
generating the scrambled data chunks each including at least two or more sub data chunks divided from different data chunks among the sub data chunks.

13. The method of claim 12, wherein generating the scrambled data chunks comprises generating the scrambled data chunks including the sub data chunks corresponding to the number of the plurality of planes.

14. The method of claim 13, wherein scrambling comprises generating scrambling information that is information on planes in which the sub data chunks are to be stored among the plurality of planes.

15. The method of claim 13, wherein generating the scrambled data chunks comprises generating the scrambled data chunks corresponding to the number of the plurality of planes.

16. A storage device comprising:
a memory device including a plurality of planes;
a buffer memory configured to allocate physical addresses indicating positions in which data chunks received from a host are stored to logical addresses received together with the data chunks, and temporarily store the physical addresses and the data chunks;
a data converter configured to convert data chunks to which physical addresses respectively corresponding to pages included in different planes among the plurality of planes are allocated into scrambled data chunks; and
an operation controller configured to provide program commands instructing to store the scrambled data chunks in the plurality of planes, to the memory device.

17. The storage device of claim 6, wherein the scrambled data chunks each include at least two or more sub data chunks that were included in different data chunks among a plurality of sub data chunks respectively included in the data chunks.

18. The storage device of claim 17, wherein the scrambled data chunks include the sub data chunks corresponding to the number of the plurality of planes.

19. The storage device of claim 16, wherein the number of scrambled data chunks are the same as the number of the data chunks.

20. The storage device of claim 16, wherein the number of scrambled data chunks are the same as the number of the plurality of planes.
